(19) United States
(12) Patent Application Publication
(10) Pub. No.: US 2011/0278773 A1
(43) Pub. Date: Nov. 17, 2011

(54) Device And Method Of Generatively Manufacturing A Three-Dimensional Object With Working Field Limitation

(75) Inventors: Attila Bokodi, Ebersberg (DE); Andreas Baumann, Grafelfing (DE)

(73) Assignee: EOS GMBH ELECTRO OPTICAL SYSTEMS, Krailing (DE)

(21) Appl. No.: 13/106,037

(22) Filed: May 12, 2011

Related U.S. Application Data
(60) Provisional application No. 61/334,836, filed on May 14, 2010.

(30) Foreign Application Priority Data
May 12, 2010 (DE) 10 2010 020 418.8

(51) Int. Cl. B29C 35/08

(52) U.S. Cl. 264/497; 425/150

(57) ABSTRACT

The present invention relates to a device and a method of generatively manufacturing a three-dimensional object in a device, comprising the following steps: layerwise applying a powdery material (11) onto a support (5) or a previously applied layer after having lowered the support (5) by the amount of one layer thickness; selectively solidifying the powdery material (11) by energetic radiation (8, 8′) at locations corresponding to the object (3); repeating the steps a) and b), until the object (3) is completed. The device defines a two-dimensional maximum working field (6) with a maximum length (L) and a maximum width (B), in which the powdery material (11) can be applied and solidified. According to the invention, a reduced working field (13) is additionally realized, in which the powdery material (11) is applied and radiated by less than the maximum length (L) and/or by less than the maximum width (B) of the maximum working field (6).

The present invention relates to a device and a method of generatively manufacturing a three-dimensional object.

DE 199 37 260 B4 describes a known device which is formed as a laser sintering machine for generatively manufacturing a three-dimensional object, comprising a frame, the upper portion thereof surrounds a working field; a support which is arranged in the frame and which is vertically movable by a lifting mechanics at least below the working field; a solidifying device which generates an energy beam which is focused by the deflection means to arbitrary points in the working field in order to selectively sintering or melting the powdery material which is present in the working field; and an application device for applying a layer of the powdery material on the support or a previously applied layer of the powdery material. The manufacturing method of this device has the following steps: a) layerwise applying a powdery material on the support of the device or a previously applied layer after having previously lowered the support by the amount of a layer thickness; b) solidifying the powdery material by energetic radiation at locations corresponding to the object, c) repeating the steps a) and b), until the object is completed.

In the upper portion of the frame, a two-dimensional maximum working field having a maximum length and a maximum width is defined, in which the powdery material can be applied and irradiated. In the vertical direction, the height of the biggest object determines the minimum height of each job. The three dimensions, that are the maximum length, the maximum width and the minimum height of each job, result in the minimum building volume, and the amount of the required powdery material can be calculated from the densities of the powder bed and the object.

If only a small amount of the powdery material is present, or when the use of material should be decreased due to cost reasons, only a very small height of the job is possible in a large support area. The situation is particularly critical, when non-solidified powdery material can only partly or sometimes not at all be recycled. A job with a large vertical height then results in large waste amounts; in particular the objects can not be favorable arranged in the frame and the building container, respectively. Usually, the waste powder can only partly be recycled.

It is the object of the present invention to provide a device and a method of generatively manufacturing a three-dimensional object, by which higher flexibility by the use of the device as well as economic use of the powder for small objects and in processing cost-intensive and non-recyclable powdery materials are enabled. Furthermore, flexible and economic development of powdery materials also for large devices shall be enabled. This object is achieved by the device having the features of claim 1 and by the method having the features of claim 4. Advantageous further developments are subject of the dependent claims.

The invention has the advantage that also small objects can be economically manufactured in a large laser sintering machine, since only the minimally required powder amount is used. Furthermore, it is possible to examine the building process with a few amount of powdery material under thermal conditions of a large laser sintering machine. Particularly, the invention offers the application of PAEK-powders, such as PEEK, PEKK, etc. as building material. Particularly, these polymer powders, which result in promising properties of the manufactured objects not only due to the high temperature stability, are only recyclable in a very restricted manner and also very expensive at present.

Further features and aims of the invention can be gathered from the description of embodiments on the basis of the enclosed figures. In the figures show:

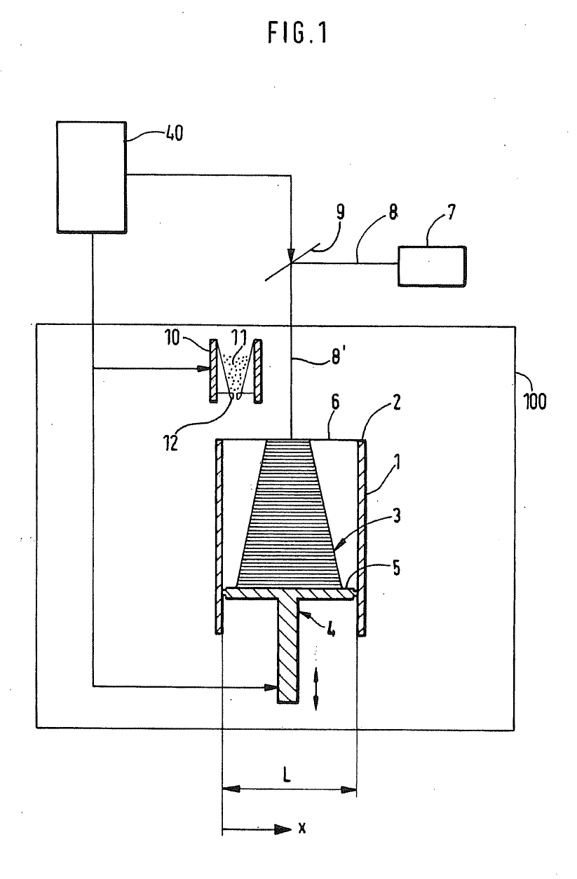

FIG. 1 a schematic view of a device for manufacturing a three-dimensional object;

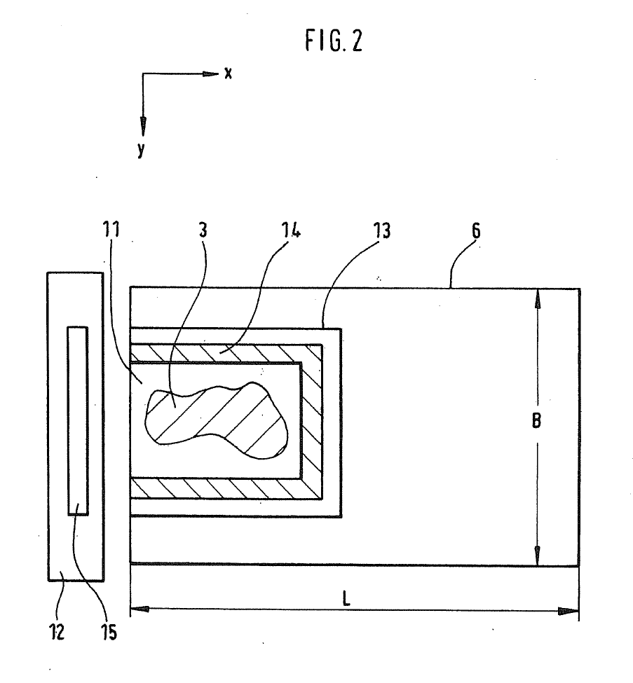

FIG. 2 a schematic view of the maximum working field and the reduced working field located therein according to an embodiment of the present invention; and

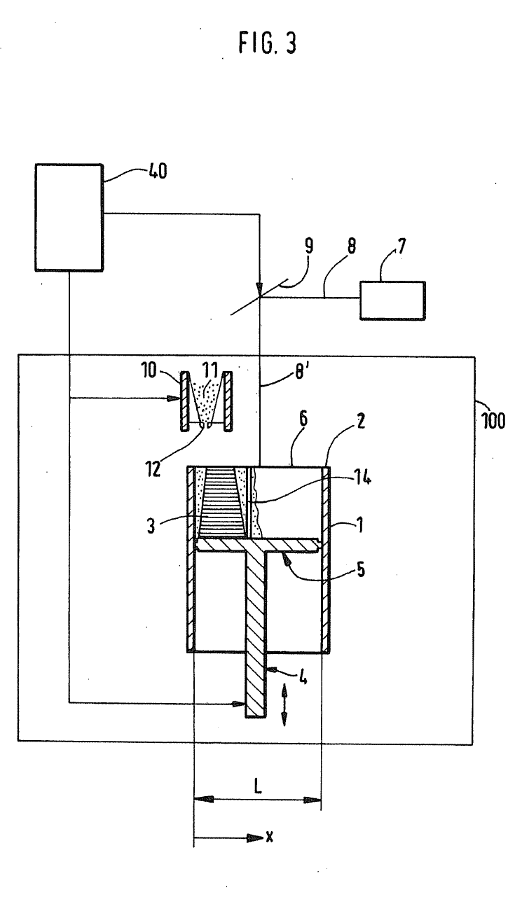

FIG. 3 a schematic cross-sectional view of the device for manufacturing a three-dimensional object having the reduced working field.

FIG. 1 shows a schematic view of a device for manufacturing a three-dimensional object 3 which is exemplarily formed as a laser sintering device.

The laser sintering device comprises a frame 1 which opens to the top and contains therein a support 5 which is movable in the vertical direction and supports the three-dimensional object 3 to be manufactured. The upper portion 2 of the frame surrounds a working field 6. Preferably, the frame 1 and the support 5 form an exchangeable replacement frame which can be removed from the laser sintering device. The support 5 is connected to a lifting mechanics 4 which moves it in the vertical direction at least below the plane of the working field 6 such that the upper side of the respective powder layer to be solidified lies in the plane of the working field 6.

Further, an application device 10 for applying a layer of the powdery material 11 is provided. As powdery material 11, all laser sinterable powders can be used, such as powder of synthetics, metals, ceramics, molding sand and compound materials. In particular, the powder can contain the PAEK polymer powder. As metalliferous powdery material, any metals and the alloys thereof as well as mixtures with metalliferous components or with non-metalliferous components come into question.

The application device 10 is moved to a predetermined height above the working field 6 so that the layer of the powdery material 11 lies in a defined height above the support 5 and above the lastly solidified layer, respectively.

The device further comprises a solidifying device in the shape of a laser 7 generating a laser beam 8, 8′ which is focused by a deflection means 9 to arbitrary points in the working field 6. Thereby, the laser beam 8, 8′ can selectively melt and solidify or sinter the powdery material 11 at those locations corresponding to the cross-section of the object 3 to be manufactured.

The laser sintering device may comprise a heating device (not shown) above the working field 6 in order to pre-heat a newly applied powder layer to a temperature near the process temperature of the powdery material 11 necessary for solidification.

Reference sign 100 designates the housing, in which the frame 1, the support 5 and the application device 10 are arranged. Preferably, the housing is gas-proof sealed and has an inlet for introducing the laser beam 8, 8′ at the upper portion. Preferably, an inert gas is introduced into the housing 100. Further, a control unit 40 is provided, by which the device is controlled in a coordinated manner to perform the building process and to control the application of energy by the laser 7. To manufacture the object 3, the control unit 40 uses data sets of the object 3 defining the geometry of the object 3, such as CAD data.

The working field 6 is shown in FIG. 1 in a lateral view, and FIG. 2 shows a schematic plan view of the working field 6 which is designated in the following as maximum working field 6 and has a maximum length L and a maximum width B, in which the powdery material 11 can be applied and irradiated. In this respect, the application device 10 is movable in the direction x along the maximum length L of the maximum working field 6.

If small objects 3 should be manufactured and the maximum width B of the working field 6 should not be used, the application device 10 can be provided with a mechanical insert 12 which is only schematically shown in FIG. 2 and limits the application of the powdery material 11 to less than the maximum width B of the maximum working field 6. Preferably, the mechanical insert 12 has an opening 15 for applying the powdery material 11, the length in the direction y thereof is smaller than the maximum width B of the maximum working field 6. Thereby, a working field 13 is defined to be reduced in the direction y, as it is shown in FIG. 2 as an example. Preferably, the mechanical insert 12 is replaceable provided at the application device 10.

In operation of the device, the support 5 is lowered in a first step by the lifting mechanics 4 until the upper side thereof lies below the plane of the working field 6 by the desired thickness of a first powder layer. Then, a first layer of the powdery material 11 is applied and smoothened on the support 5 by the application device 10.

The method according to the invention has a normal operation mode, in which the powdery material 11 is applied and irradiated within the maximum working field 6. The method according to the invention further has a specific operation mode with reduced working field 13, in which the powdery material 11 is applied and irradiated in an area having a length smaller than the maximum length L, and by use of the insert 12, having also a width smaller than the maximum width B of the maximum working field 6.

If small objects 3 shall be manufactured and the maximum length L of the working field 6 shall not be used, the application device 10 can also apply the powdery material 11 in the direction x in an area having a reduced length compared with the maximum length L of the working field 6, that is, the application device 10 reverses its movement direction before reaching the maximum length L of the working field 6. Thereby, the reduced working field 13 is narrowed in the direction x, as shown in FIG. 2 as an example. For example, the limitation of the reduced working field 13 in the direction x is structurally realized by the control unit 40 which functions as working field limitation device 40 and is programmed such that the application device 10 is not moved over the whole distance L in the direction x, but only up to the border of the reduced working field 13 in the direction x.

Since the reduced working field 13 does not extend up to the walls of the frame 1, which hold the applied powdery material 11 before solidification, the job takes place in a layer structure of non-solidified powdery material. It was surprisingly found out that even a slope angle of approximately 90° can be realized because of adhesive power which is usually present between the powder particles, so that objects having arbitrary three-dimensional shapes can be realized in spite of the absence of limiting walls. FIGS. 2 and 3 show a particular embodiment of the invention. Here, supporting walls 14 are manufactured in addition to the three-dimensional object 3 during the laser sintering process, which extend around the object 3 and prevent that the applied powder 11 escapes from the reduced working field 13.

Preferably, the reduced working field 13 substantially flushes with that side of the maximum working field 6, at which the application device 10 enters into the working field 6, since the application action can not start in the middle of the working field 6 when it is continuously performed from an application filling station outside of the working field 6.

A job by use of the specific operation mode with reduced working field is executed as follows:

After having applied the powdery material 11, it can be solidified at the desired locations. If the heating device is provided, the temperature of the uppermost powdery material 11 can be globally set to some ° C. below the process temperature necessary for solidification by the heating device. Thereafter, the control unit 40 then controls the deflection means 9 such that the deflected laser beam 8, 8′ selectively impacts at the locations of the layer of the powdery material 11 to be solidified. Thereby, the powdery material 11 is solidified or sintered at these locations so that the three-dimensional object 3, and if necessary, the supporting walls 14 are generated.

In a next step, the support 5 is then lowered by the lifting mechanics 4 by the desired thickness of the next layer. By the application device 10, a second layer of powdery material is applied, smoothened and selectively solidified by the laser beam 8, 8′. These steps are whenever performed, until the desired object 3, and if necessary, the supporting walls 14 are manufactured.

Since the control unit 40 for manufacturing the object 3 uses CAD data sets of the object 3, for example, which define the geometry of the object 3, the data sets shall be supplemented with the CAD data of the supporting walls 14, if necessary. At this time, a data set is first generated in a common manner defining the geometry or the dimensions of the completed three-dimensional object 3. Thereafter, the data set is supplemented by data defining the geometry or the dimensions of the supporting walls 14. Thereby, the supporting walls 14 can be manufactured at the same time with the inherent object 3 by the laser sintering machine.

The scope of protection is not restricted to the described embodiments, but it includes further modifications and alterations, provided that these fall within the scope as defined by the enclosed claims.

In the described embodiment, a rectangular maximum working field 6 as well as a rectangular reduced working field 13 are described. However, the invention is not restricted to these shapes, since the working fields 6, 13 may have different shapes, for example the working field 6 as rectangle having rounded corners. The working fields 6, 13 may also be circular, wherein the maximum length and the maximum width of the working field correspond to the diameter of the circle in this case. Oval working fields 6 are also possible. Generally, the shape of the reduced working field 13 is not limited to the shape of the maximum working field 6 or to the shape of the upper portion 2 of the frame 1. In accordance to the kind of application, different shapes of the reduced working field 13 are conceivable. For example, in devices which comprise a circular cross-section of the frame 1, the reduced working field 13 may also have the shape of a segment of a circle in linear application, or it may have circular shape having a reduced radius as compared with the frame 1 in rotating application.

In the described embodiment, the supporting walls 14 are manufactured at the same time with the object 3 by the same manufacturing process. The device according to the invention is not only applicable to laser sintering, but also to all generative methods on powder basis, in which for example one work piece or powdery material is used for each applied layer to be solidified by the energetic radiation. The energetic radiation is not necessarily a laser beam 8′, but it can also be an electron beam or a particle beam, for example.

Furthermore, a radiation over the whole surface is possible, for example by a mask. Instead of the energetic radiation, also an adhesive or a binder can be applied at the desired locations, which selectively glues the powdery material.

1-6. (canceled)

7. Device for generatively manufacturing a three-dimensional object, comprising:
a frame, the upper portion thereof surrounding a working field;
a support which is arranged in the frame and is vertically movable by a lifting mechanism at least below the working field;
an application device adapted to apply a layer of a powdery material onto the support or a previously applied layer of the powdery material in the working field;
a solidifying device capable of selectively solidifying the powdery material present in the working field at locations corresponding to the cross-section of the object in the applied layer; wherein
the working field is a two-dimensional maximum working field having a maximum length, in which the application device is movable over the working field, and a maximum width, in which the application device can apply the powdery material; and
the application device comprises a mechanical insert which limits the application of the powdery material to less than the maximum width of the maximum working field, and/or the device comprises a working field limitation device which limits the movement path of the application device to less than the maximum length of the maximum working field so that a reduced working field is defined.

8. Device according to claim 7, wherein the mechanical insert comprises an opening, the width thereof in a direction of the maximum width of the working field being smaller than the maximum width of the maximum working field.

9. Device according to claim 7, wherein the mechanical insert is replaceable.

10. Device according to claim 8, wherein the mechanical insert is replaceable.

11. Method of generatively manufacturing a three-dimensional object in a device, comprising the following steps:
a) layerwise applying a powdery material onto a support of the device or a previously applied layer;
b) selectively solidifying the powdery material at the locations corresponding to the cross-section of the object in the applied layer;
c) repeating the steps a) and b), until the object is completed; wherein
the device defines a two-dimensional maximum working field having a maximum length and a maximum width, in which the powdery material can be applied; and
the method comprises a normal operation mode, in which the powdery material is applied in the maximum working field, and a specific operation mode with reduced working field, in which the powdery material is applied by less than the maximum length and/or less than the maximum width of the maximum working field.

12. Method according to claim 11, wherein a length and a width of the three-dimensional object decrease upwardly.

13. Method according to claim 11, wherein, in addition to the three-dimensional object, supporting walls are manufactured which extend around the object in the reduced working field and prevent the applied powder from escaping from the reduced working field.

14. Method according to claim 12, wherein, in addition to the three-dimensional object, supporting walls are manufactured which extend around the object in the reduced working field and prevent the applied powder from escaping from the reduced working field.
